(19) United States
(12) Patent Application Publication
(10) Pub. No.: US 2003/0154089 A1
(43) Pub. Date: Aug. 14, 2003

(54) Commercial transaction support apparatus, commercial transaction support system, customer terminal device, commercial transaction support method, and commercial transaction support program

(75) Inventor: Nao Sone, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 10/196,212

(22) Filed: Jul. 17, 2002

(30) Foreign Application Priority Data
Feb. 12, 2002 (JP) 2002-33671

(51) Int. Cl. G06F 17/60

(52) U.S. Cl. 705/1; 705/15

(57) ABSTRACT

Product transactions between a store and a customer are expedited and smoothed by enabling a menu available at the store at the time of transaction to be known beforehand, and consequently enabling transaction time to be shortened by enabling a product to be ordered immediately on arrival at the store, thereby enabling sales productivity to be increased for the store, and eliminating the need for long waiting times for the customer to purchase a product and also preventing the customer's expectations concerning the menu from being disappointed.

A managing server can be connected to a customer terminal possessed by a customer such that when information relating to a store and a time of day is received from the customer terminal as electronic data, menu information concerning a menu available at the store at that time of day is extracted from a database and the extracted menu information is transmitted to the customer terminal as electronic data.

### BACKGROUND OF THE INVENTION

1. Field of the Invention

The present invention relates to a commercial transaction support apparatus, a commercial transaction support system, a customer terminal device, a commercial transaction support method, and a commercial transaction support program enabling a date and time for coming to a store to perform a transaction such as ordering products from the store and purchasing those products, etc., to be designated before coming to the store using a portable terminal or the World Wide Web, for example.

2. Description of the Related Art

Conventionally, when purchasing products at a store in the food service industry such as a fast food store, or a restaurant, for example, a customer first needs to know what kind of products are available. Because of this, a menu is conventionally presented to the customer indicating what kind of products are provided by the store. When ordering products, it is usual for the customer to look over the menu and familiarize himself or herself with what kind of products are available before placing an order.

Consequently, in a conventional technique of this kind, customers who do not know the menu cannot place an order immediately on arrival at a store, and cases often arise where a lot of time is taken from arrival at the store until an order is placed, and stores often become congested by such customers.

For example, in fast food stores or the like, products are supplied after taking orders from customers at the store in the order that they line up in front of the counter, but if those customers require a lot of time to select products at the counter, subsequent customers cannot place orders, and long queues form in front of the counter, resulting in long waiting times for the customers and poor sales productivity for the store. In stores employing systems such as drive-thrus, etc., in particular, unless the time interval until handing over of products to a customer is kept short, the number of waiting vehicles increases, forcing the need for space to be reserved to accommodate them, thereby making the time interval a large cost factor.

Thus, conventionally, since the system is such that the customers see the menu for the first time after coming to the store, a lot of time is required from arrival at the store until the desired products are selected, and one problem has been that the time required before the products are received has tended to be long.

Furthermore, separate to problems of waiting time, cases also arise in which customers find out for the first time after coming to the store that a desired product is not offered at the store, and in such cases, the customers' expectations are disappointed. Furthermore, some customers are already aware that certain products are on the menu at a given store, and many come to the store with expectations of this, but menus are often changed periodically, seasonally, or even depending on the time of day, and when it is discovered on arrival at the store that the product desired by the customer is not available, the customers' expectations may be terribly disappointed.

### SUMMARY OF THE INVENTION

The present invention aims to solve the above problems and an object of the present invention is to provide a commercial transaction support apparatus, a commercial transaction support system, a customer terminal device, a commercial transaction support method, and a commercial transaction support program enabling product transactions between a store and a customer to be expedited and smoothed by enabling a menu available at the store at the time of transaction to be known beforehand, and consequently enabling transaction time to be shortened by enabling a product to be ordered immediately on arrival at the store, thereby enabling sales productivity to be increased for the store, and eliminating the need for long waiting times for the customer to purchase a product and also preventing the customer's expectations concerning the menu from being disappointed.

In order to solve the problems described above, according to one aspect of the present invention, there is provided a commercial transaction support apparatus including:

a means for receiving as electronic data information relating to a store and a time of day;

a menu information extracting means for extracting from an information source menu information concerning a menu available at the store at the time of day; and

a means for transmitting as electronic data to a predetermined device the menu information extracted by the menu information extracting means.

Here, the store and the time of day can be transmitted from a terminal device possessed by the customer, for example, and the predetermined device to which the menu information is transmitted may similarly be the terminal device possessed by the customer, or it may also be another apparatus indicated by the customer, etc., or even a display device possessed by the commercial transaction support apparatus itself. Furthermore, this commercial transaction support apparatus may also be disposed as a server device at a center, for example, or it may also be disposed at each of a plurality of stores.

Using this construction, by enabling the menu information to be transmitted to and downloaded by the customer terminal device, when the customer is going to go out to a given store at a given time of day, for example, he or she can find out beforehand what kinds of products are available at the store at that time of day, and can decide before going to the store which product he or she is going to purchase, enabling the transaction time after arriving at the store to be shortened. Furthermore, situations such as the customer thinking that a given product is available, then finding on going to the store that the product is not actually available are also eliminated, preventing disappointment of expectations. Moreover, besides menu information concerning a menu available at a store such as a restaurant, etc., information such as products, inventory, etc., broadly handled at stores at that time of day may also be included in the menu information.

The commercial transaction support apparatus may also include:

a storage means for storing menu information concerning a menu at the store in association with a time of day, the menu information extracting means extracting menu information using the storage means as the information source.

Using this construction, management and maintenance of a database, etc., for example, functioning as the information source are facilitated.

Moreover, it is also possible to dispose a database in each store as the information source, and to enable the menu information extracting means to extract the menu information by accessing those as the information source by means of a communication line.

The commercial transaction support apparatus may also include:

a means for extracting from an information source special offer information related to the menu information extracted by the menu information extracting means and transmitting the special offer information in association with the menu information.

Using this construction, since special offer information is added in association with the menu information, the customer can select the product that he or she is going to buy more pertinently.

The commercial transaction support apparatus may also include:

a means for receiving as electronic data information concerning a commercial product selected based on the transmitted menu information; and

a means for displaying as order information information concerning the received commercial product and a time of day for trading the product.

Using this construction, the order information can be made known at the store, for example, before the customer comes to the store, making it possible to time the provision of the product with the arrival of the customer at the store. Moreover, the means for displaying the order information is constituted by the display device of the apparatus itself if this commercial transaction support apparatus is disposed at a store, but signifies a means for transmitting the order information to each of the stores and displaying it on the apparatuses in the stores if the commercial transaction support apparatus is disposed as a server at a center, etc.

The commercial transaction support apparatus may also include:

a means for obtaining as electronic data information relating to a method of payment by a customer for the commercial product,

the method of payment being displayed as order information together with the information concerning the commercial product and the time of day for trading the product.

Using this construction, because the method of payment can be made known at the store beforehand together to the ordered product and the time of day that the customer will come to the store, for example, it is possible to make preparations for the payment in advance.

Moreover, by including a managing means for managing the order information by electronic data, commercial transaction management can be accomplished smoothly and reliability can be improved.

The commercial transaction support apparatus may also include:

a means for receiving as electronic data inquiry information concerning a store in a predetermined area;

a store information extracting means for extracting as electronic data from an information source store information concerning the store in the predetermined area; and

a means for transmitting to a predetermined device as electronic data the store information extracted by the store information extracting means.

Using this construction, because it is possible to find out what kinds of stores, such as restaurants, etc., are available even in an unfamiliar area, for example, and in addition it is possible to find out menu information concerning the menu available there, it is possible to find a desirable store easily.

According to yet another aspect of the present invention, there is provided a commercial transaction support system for supporting a commercial transaction, the commercial transaction support system including:

a customer terminal device possessed by a customer; and

a server device capable of being connected to the customer terminal device by means of a communication line,

wherein:

the server device is provided with:

a means for receiving as electronic data from the customer terminal device information relating to a store and a time of day;

a menu information extracting means for extracting as electronic data from an information source menu information concerning a menu available at the store at that time of day; and

a means for transmitting as electronic data to the customer terminal device the menu information extracted by the menu information extracting means, and

the customer terminal device is provided with:

a means for displaying the menu information concerning the menu transmitted from the server device and enabling a desired commercial product to be selected and transmitted to the server device as electronic data.

According to yet another aspect of the present invention, there is provided a commercial transaction support system for supporting a commercial transaction, the commercial transaction support system including:

a customer terminal device possessed by a customer;

a store terminal device disposed in a store; and

a server device capable of being connected to the terminal devices by means of a communication line,

wherein:

the server device is provided with:

a means for receiving as electronic data from the customer terminal device information relating to a store and a time of day;

a menu information extracting means for extracting from an information source menu information concerning a menu available at the store at that time of day;

a means for transmitting as electronic data to the customer terminal device the menu information extracted by the menu information extracting means,

a means for receiving as electronic data information relating to a commercial product and a time of day for trading the product transmitted from the customer terminal device based on the transmitted menu information; and

a means for transmitting as electronic data to the store terminal device the received information relating to the commercial product and the time of day for trading the product,

the customer terminal device is provided with:

a means for displaying the menu information concerning the menu transmitted from the server device and enabling a desired commercial product and a time of day for trading the product to be selected and transmitted to the server device, and

the store terminal device is provided with:

a means for receiving and displaying the received information relating to the commercial product and the time of day for trading the product transmitted from the server device.

According to yet another aspect of the present invention, there is provided a customer terminal device capable of being connected to a predetermined device, the customer terminal apparatus including:

a means for transmitting as electronic data to the predetermined device information relating to a store and a time of day;

a means for receiving menu information concerning a menu available at the store at that time of day transmitted as electronic data from the predetermined device based on the information relating to the store and the time of day;

a means for displaying the received menu information and enabling selection of a desired product; and

a means for transmitting information concerning the selected desired product to the predetermined device as electronic data.

According to another aspect of the present invention, there is provided a commercial transaction support method including:

a step of receiving as electronic data information relating to a store and a time of day;

a step of extracting as electronic data from an information source menu information concerning a menu available at the store at that time of day; and

a step of transmitting the extracted menu information as electronic data to a predetermined device.

According to yet another aspect of the present invention, there is provided a commercial transaction support program recorded on a recording medium readable by a computer and executed by a computer of a commercial transaction support apparatus for supporting a commercial transaction, the commercial transaction support program executing in the computer:

a step of receiving information relating to a store and a time of day;

a step of extracting from an information source menu information concerning a menu available at the store at that time of day; and

a step of transmitting the extracted menu information to a predetermined device.

### BRIEF DESCRIPTION OF THE DRAWINGS

FIG. 1 is a conceptual diagram conceptually showing a construction in a preferred embodiment of the present invention;

FIG. 2 is a block diagram showing an overall construction of the preferred embodiment;

FIG. 3 is a diagram showing a customer table;

FIG. 4 is a diagram showing a payment classification table;

FIG. 5 is a diagram showing a card information table;

FIG. 6 is a diagram showing a card type table;

FIG. 7 is a diagram showing a store area code table;

FIG. 8 is a diagram showing a store table;

FIG. 9 is a diagram showing a menu table;

FIG. 10 is a diagram showing a time period table;

FIG. 11 is a diagram showing a store-menu correspondence table;

FIG. 12 is a diagram showing a special offer contents table;

FIG. 13 is a flowchart showing a customer registration process;

FIG. 14 is a flowchart showing a special offer information delivery process;

FIG. 15 is a flowchart showing an order receiving process;

FIG. 16 is a flowchart showing store-side processing;

FIG. 17 is a diagram showing a store search screen;

FIG. 18 is a diagram showing a search result screen;

FIG. 19 is a diagram showing an order initial screen;

FIG. 20 is a diagram showing a menu item selection screen;

FIG. 21 is a diagram showing an order confirmation screen;

FIG. 22 is a diagram showing an order receipt table (Pattern 1);

FIG. 23 is a diagram showing an order receipt table (Pattern 2);

FIG. 24 is a diagram showing order data;

FIG. 25 is a diagram showing another example of order data; and

FIG. 26 is a diagram showing an order data screen.

### DETAILED DESCRIPTION OF THE PREFERRED EMBODIMENT

A preferred embodiment of the present invention will now be explained with reference to the drawings.

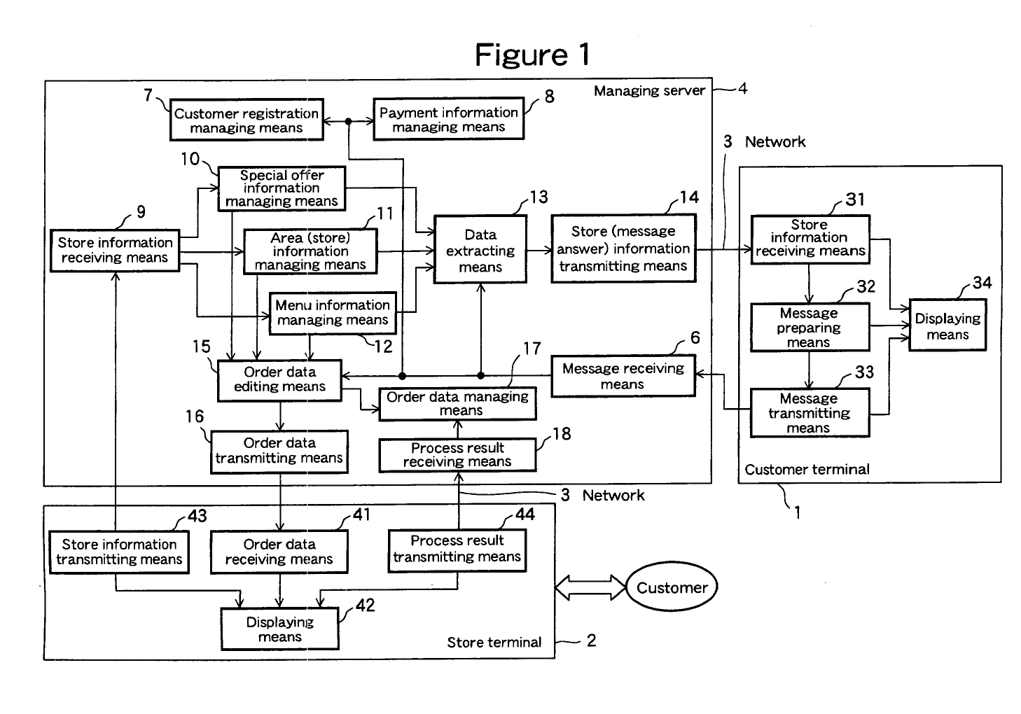

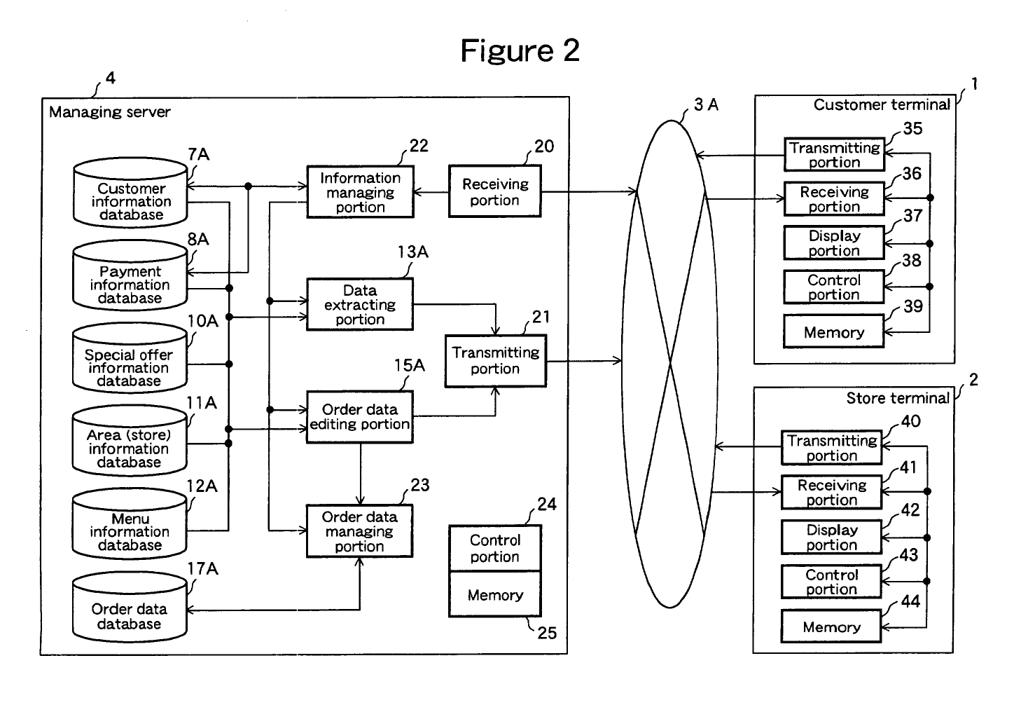

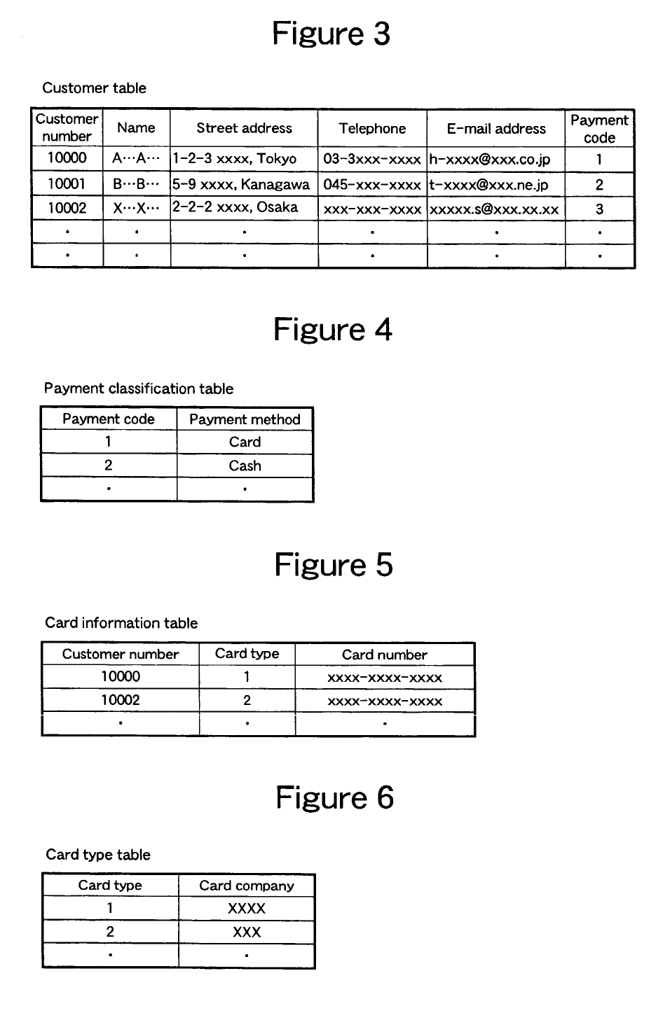

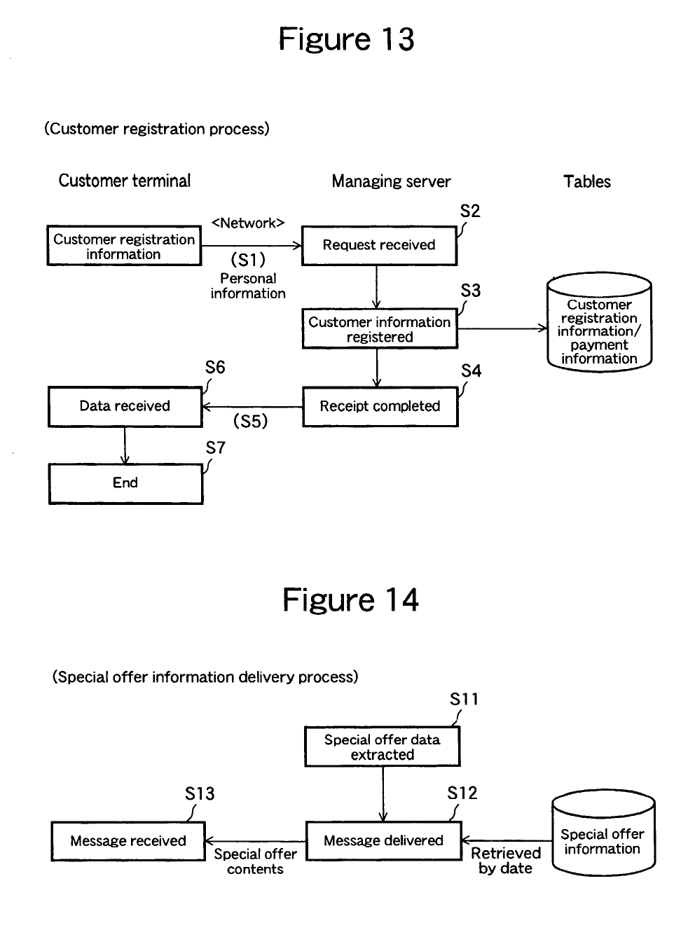

FIG. 1 is a conceptual diagram conceptually showing a construction in a preferred embodiment of the present invention, FIG. 2 is a block diagram showing an overall construction of the preferred embodiment, FIGS. 3 to 12 are diagrams showing various tables stored in a database, and FIGS. 13 to 16 are flowcharts showing various operations.

First, a conceptual construction of a preferred embodiment of the present invention will be explained with reference to FIG. 1. The preferred embodiment of the present invention is constituted by: a customer terminal (customer terminal device) 1 possessed by a customer; a store terminal (store terminal device) 2 possessed by a store; and a managing server 4 capable of being connected to the customer terminal 1 and the store terminal 2 by a network 3 such as the Internet, etc., for performing predetermined operations described below.

The managing server 4 is provided with: a message receiving means 6 for receiving various messages received from the customer terminal 1; a customer registration managing means 7 for registering customer information and a payment information managing means 8 for managing information relating to the customer's method of payment obtained by the message receiving means 6; a store information receiving means 9 for receiving various information received from the store terminal 2; and a special offer information managing means 10 for registering and managing special offer information, an area (store) information managing means 11 for registering and managing area information (store information), and a menu information managing means 12 for registering and managing menu information based on the various information received by the store information receiving means 9.

The managing server 4 is also constructed so as to be provided with: a data extracting means 13 for preparing transmission data by extracting predetermined information from the special offer information managing means 10, the area (store) information managing means 11, and the menu information managing means 12 based on the messages from the customer obtained by the message receiving means 6; a store (message answer) information transmitting means 14 for transmitting the transmission data prepared by the data extracting means 13 to the customer terminal 1 as a message answer; and an order data editing means 15 for editing the customer's order data based on the information obtained by the customer registration managing means 7, the various information managing means 10 to 12, the payment information managing means 8, and the message receiving means 6, and to be provided with: an order data transmitting means 16 for transmitting the order data edited by the order data editing means 15; an order data managing means 17 for managing the order data edited by the order data editing means 15; and a process result receiving means 18 for receiving a process result from the store terminal and conveying the process result to the order data managing means 17.

The customer terminal 1 is constructed so as to be provided with: a store information receiving means 31 for receiving various messages transmitted from the store (message answer) information transmitting means 14 of the managing server 4 by means of a communication line such as the network 3, etc.; a message preparing means 32 for preparing predetermined messages based on the store information received by the store information receiving means 31 or independently; a message transmitting means 33 for transmitting the messages prepared by the message preparing means 32; and a displaying means 34 for displaying predetermined information handled by each of the means 31 to 33.

The store terminal 2 is constructed so as to be provided with: an order data receiving means 41 for receiving order data transmitted from the order data transmitting means 16 of the managing server 4 by means of a communication line such as the network 3, etc.; a store information transmitting means 43 for transmitting predetermined information relating to the store to the managing server 4; a process result transmitting means 44 for transmitting process results such as sale processes for the order data, etc., to the process result receiving means 18 of the managing server 4; and a displaying means 42 for displaying the order data received by the order data receiving means 41 to store staff, etc., to enable the sale process to be performed smoothly and efficiently, and for displaying the store information and the process results. The information transmitted by the store information transmitting means 43 is stored by the various information managing means 10 to 12 and transmitted to the customer terminal 1 when required, such as when requested by the customer as described below. Thus, using the present apparatus, the various information managing means 10 to 12 can constantly manage the most up-to-date information transmitted from the store terminal 2, enabling the most up-to-date information to be provided to the customer.

In the preferred embodiment of the present invention shown in FIG. 2, the managing server 4 is provided with: a receiving portion 20 for receiving various data and information via a network 3A; a transmitting portion 21 for transmitting various data and information via the network 3A; and as databases for storing various information; a customer information database 7A for storing customer information being information relating to customers contained in messages received by the receiving portion 20; a payment information database 8A for storing payment information determining a method of payment in case of product purchases by a customer; a special offer information database 10A for storing special offer information for stores; an area (store) information database 11A for storing store information about geographical positions, etc., of the stores; a menu information database 12A for storing menu information for stores such as restaurants, etc.; and an order data database 17A for storing and managing customer order data for the stores. An order data managing portion 23 for managing the order data is also provided.

In addition, the management server 4 is provided with: a data extracting portion 13A for extracting predetermined data from the databases including the customer information database 7A through to the menu information database 12A in accordance with the messages from the customers and handing the predetermined data over to the transmitting portion 21; and an order data editing portion 15A for editing order data from the databases including the customer information database 7A through to the menu information database 12A in accordance with the messages from the customers and handing the order data over to the transmitting portion 21 as well as handing it over to the order data managing portion 23. Moreover, the management server 4 is provided with: a control portion 24 constituted by a CPU or the like for controlling the entire device; and a memory 25 (which may be any generic form of semi-conductor or magnetic memory such as a CD-ROM, a floppy disk, a DVD disk, a magneto-optical (MO) disk, a portable memory medium such as an IC card, etc., a hard disk, etc.) being a medium readable by a computer for storing a program for executing control by the control portion 24.

The customer terminal 1 is provided with a transmitting portion 35, a receiving portion 36, and a display portion 37, personal data information for registering to become a user member of the present system, showing that one is a member, etc., data transmission request information for requesting predetermined information relating to a store (making an enquiry), or order data information for designating a product to be purchased together with a date and time for coming to the store, etc., being transmitted as messages from the transmitting portion 35. Data transmitted from the managing server 4 in response to the data transmission request information (response information), etc., is received in the receiving portion 36. The display portion 37 conveniently displays the information to be transmitted from the transmitting portion 35, and conveniently displays the information received by the receiving portion 36. Moreover, the customer terminal 1 is provided with: a control portion 38 constituted by a CPU or the like for controlling the customer terminal 1; and a memory 39 (a semiconductor memory, or a magnetic memory, etc., similar to that described above) being a medium readable by a computer for storing a program for executing control by the control portion 38.

The store terminal 2 is provided with a transmitting portion 40, a receiving portion 41, and a display portion 42, special offer information, area (store) information, and menu information being transmitted as store information from the transmitting portion 40. Order data from customers transmitted by the managing server 4 is received in the receiving portion 41 and displayed by the display portion 42. Moreover, the store terminal 2 is provided with: a control portion 43 constituted by a CPU or the like for controlling the store terminal 2; and a memory 44 (a semiconductor memory, or a magnetic memory, etc., similar to that described above) being a medium readable by a computer for storing a program for executing control by the control portion 43.

FIG. 3 shows a customer table showing customer information stored in the customer information database 7A. Customer numbers allocated to each customer, family and given names, street addresses, telephone numbers, e-mail addresses, and payment codes for indicating methods of payment are shown in this customer table. Specific contents of each of the payment codes are shown in the tables in FIGS. 4 to 6, which are stored in the payment information database 8A. First, FIG. 4, being a payment classification table, indicates that if the payment code is “1”, payment by card is performed, and if the payment code is “2”, payment by cash is performed. For “card payments”, corresponding to the payment code “1”, a card information table shown in FIG. 5 is provided, card types and card numbers corresponding to each customer number being stored therein. The card types are provided so as to correspond to each card company as shown in FIG. 6.

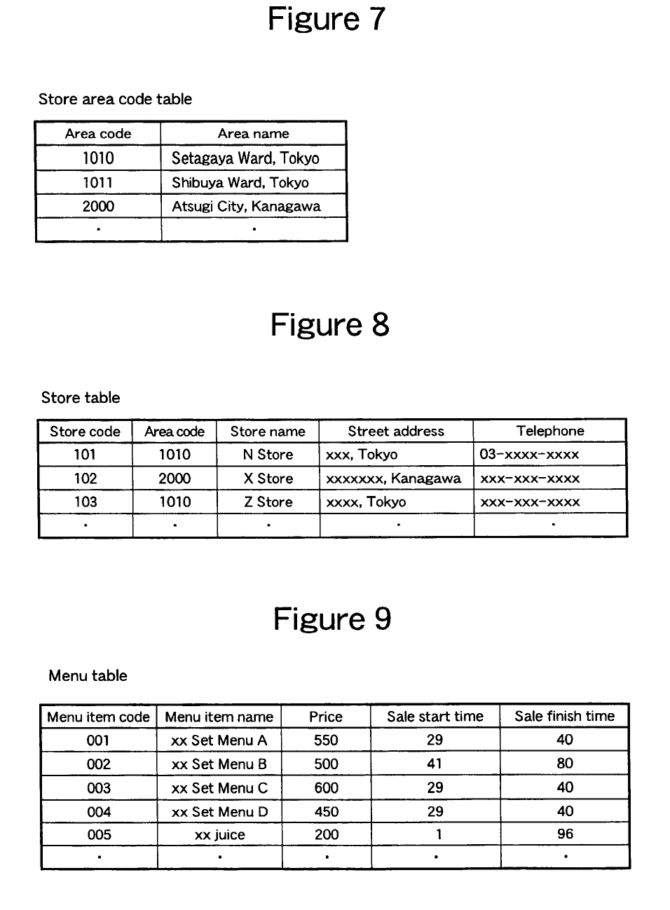

FIGS. 7 and 8 show various tables stored in the area (store) information database 11A which stores the area (store) information. A store area code table, shown in FIG. 7, is a table showing what kinds of stores (for example, restaurants, fast-food stores, etc.) exist in each area, area codes being disposed in this table so as to correspond to each area name. A store code indicating a store, an area code for that store, a store name for that store, a street address, and a telephone number for that store are given in a store table, shown in FIG. 8.

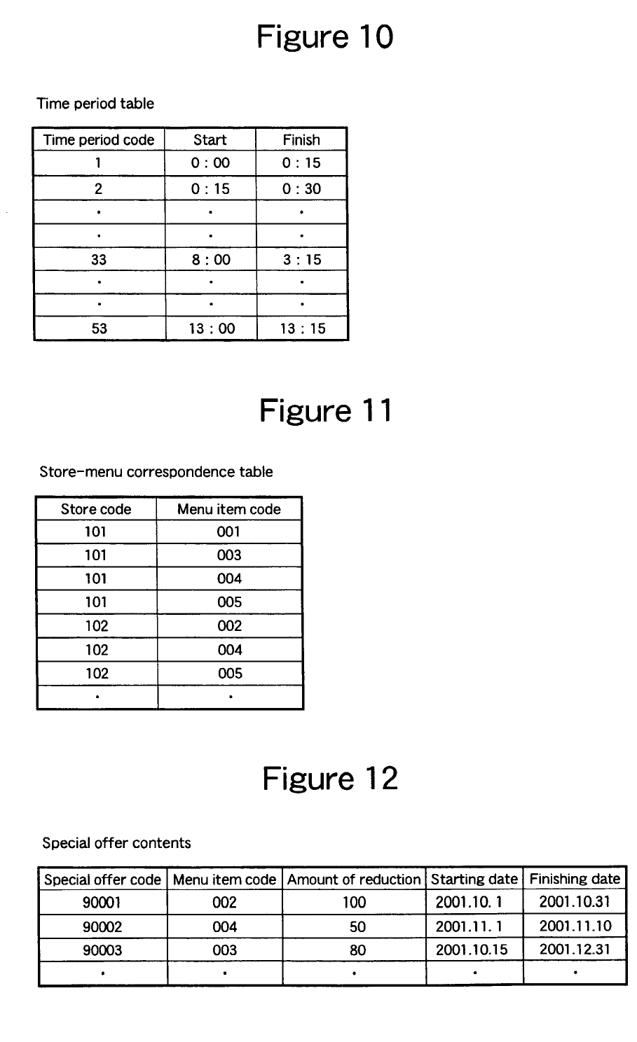

FIGS. 9 to 11 show various tables stored in the menu information database 12A. A menu table, shown in FIG. 9, is a table showing menu item codes, a menu item name and a price for each, and a sale start time and sale finish time for that menu item. The sale start time and the sale finish time of the menu items are shown as time period codes, the time period codes being specified in a time period table in FIG. 10. The start time and the finish time prescribed by each of the time period codes are specified in the time period table shown in FIG. 10. FIG. 11 shows a store-menu correspondence table, menu item codes corresponding to a store code being stored therein to establish relationships between each store and the menu items provided by that store.

FIG. 12 shows a special offer contents table showing special offer contents stored in the special offer information database 10A. Menu item codes, amounts of price reduction, and starting and finishing dates for each special offer are specified in this special offer contents table so as to correspond to a special offer code.

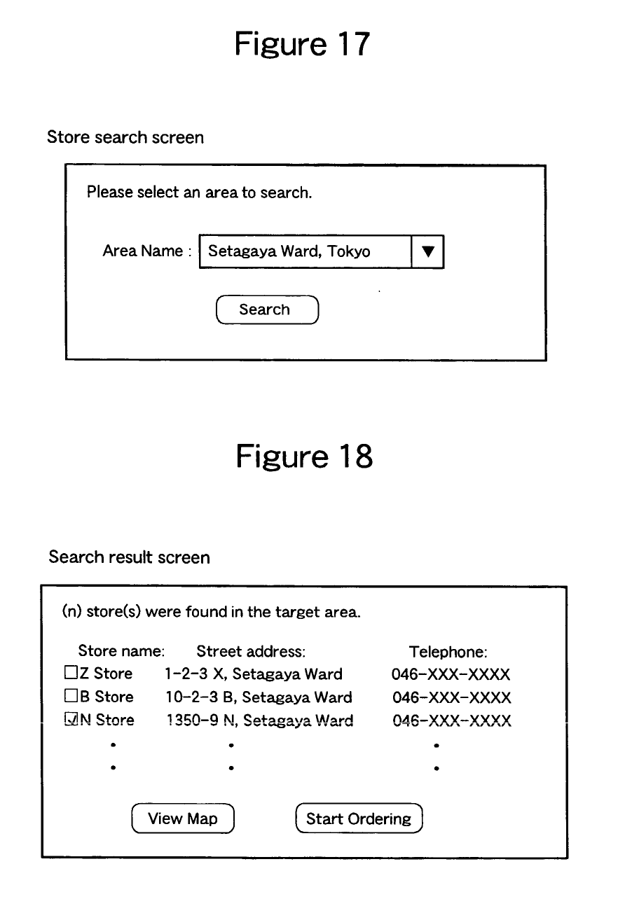

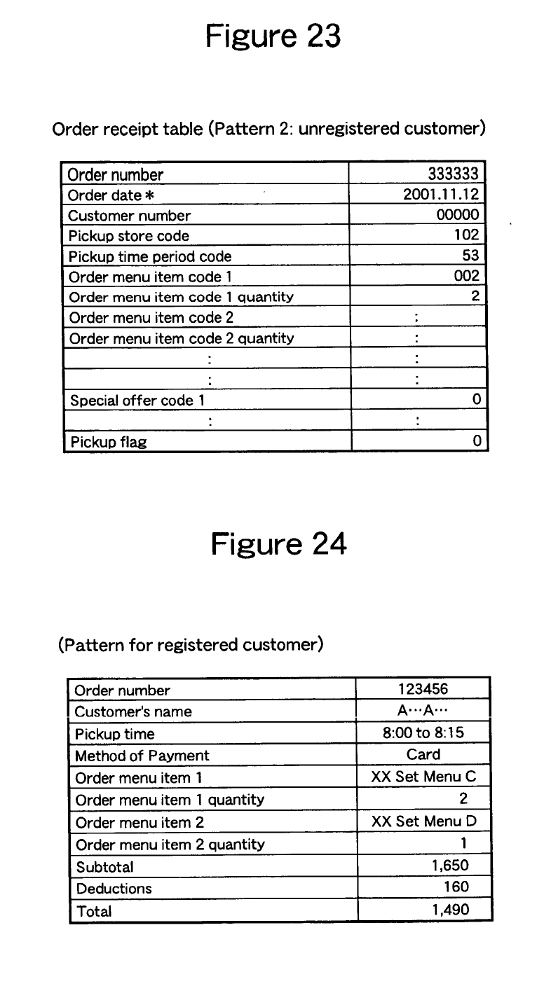

Operation of the preferred embodiment of the present invention will be explained below using flowcharts shown in FIGS. 13 to 16, display screens shown in FIGS. 17 to 22, and data shown in FIGS. 23 to 26.

FIG. 13 is a flowchart showing a customer registration process for registering customers into the present system. Personal information relating to predetermined customer registration information is transmitted to the managing server from a customer terminal 1 which has accessed the managing server in accordance with information on the Web (S1). In the managing server 4, a membership registration request is received (S2), and customer information is registered in the customer information database 7A and payment information registered in the payment information database 8A (S3). When receipt is completed (S4), notification of receipt is transmitted to the customer terminal (S5), and that notification data is received by the customer terminal 1 (S6), completing the customer registration process (S7).

FIG. 14 is a flowchart showing a special offer information delivery process, being one of the services performed by the present system for customer terminals of customers who have completed customer registration. According to the present embodiment, special offer contents are retrieved from the special offer information database 10A by date and extracted (S11), then delivered as messages at predetermined time intervals (S12). By receiving these messages using the customer terminals 1 (S13), it is possible for the customers to find out what kind of the special offers are available on a particular day.

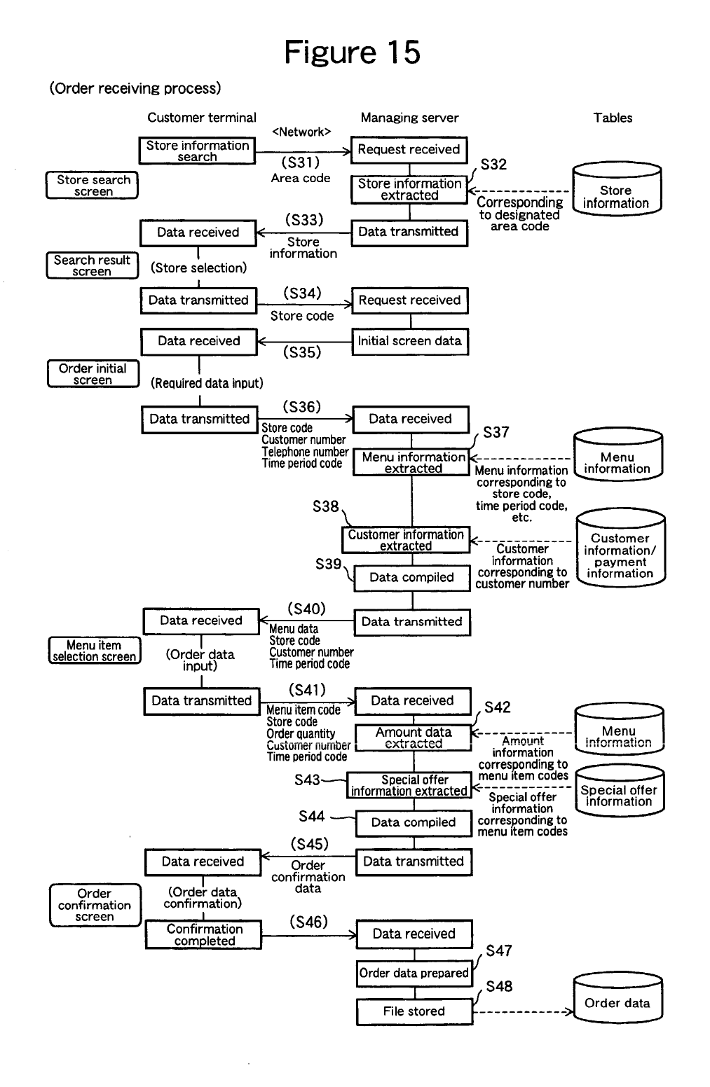

FIG. 15 is a flowchart showing an order receiving process performed between a customer terminal and the managing server 4. When placing an order according to the present system from a customer terminal 1, a store search screen such as that shown in FIG. 17, for example, is displayed on the display portion 37 of the customer terminal. The store search screen shown in FIG. 17 selectably displays areas to be searched, and it is possible to ask the managing server 4 to refer stores in the selected area by pressing a “Search” button at the selected area. This selected area name is transmitted to the managing server 4 as data specifying the area code (S31), and in the managing server 4 store information is retrieved and extracted based on this area code (S32) and transmitted as store information data (S33).

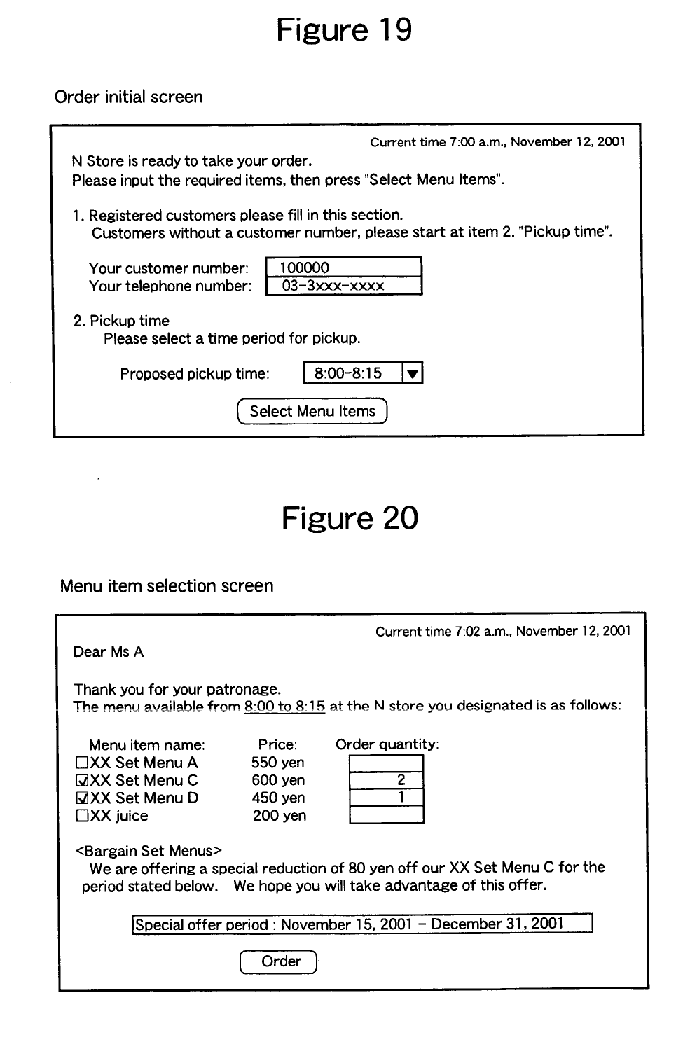

When the data from the managing server 4 is received at the customer terminal 1, a search result screen such as that shown in FIG. 18 is displayed based on the received data. In the search result screen in FIG. 18, the customer places a check mark “ ” next to the store where the order will be placed, and when a “Start Ordering” button is pressed, the name for that store is transmitted to the managing server 4 as data specifying a store code (S34), and after receiving the request at the managing server 4, an order initial screen data such as that shown in FIG. 19 is transmitted to the customer terminal 1 (S35). Moreover, in the search result screen shown in FIG. 18, when it is desirable to refer to a map of the selected store, a map of the vicinity of the store in question can be transmitted together with the order initial screen, or before transmission of the order initial screen by pressing a “View Map” button.

On the order initial screen shown in FIG. 19, an item for inputting a customer number and a telephone number is displayed as item “1.”, and an item for selecting and designating a pickup time (a time of day for coming to the store) as item “2.”, registered customers being able to start the operation from item “1.” and unregistered customers from item “2.” Then, when that operation is completed, data specifying the store code, the customer number, the telephone number, and the pickup time period code are transmitted to the managing server 4 by pressing a “Select Menu Items” button (S36).

When the above data is received, for an order from a registered customer, the managing server 4 extracts the store code and menu information corresponding to the pickup time period code from the menu information database 12A (S37), extracts the customer information and the method of payment from the customer information database 7A and the payment information database 8A (S38), compiles data to be displayed on a menu item selection screen on the customer terminal 1 (S39), and transmits the compiled data to the customer terminal 1 (S40). Moreover, although not shown, if there is a special offer related to the menu information, that can also be extracted from the special offer information database 10A before this data compilation (S39) and added in.

When the data is received, a menu item selection screen such as that shown in FIG. 20 is displayed on the customer terminal 1. Here, various menu items for the predetermined time period (from 8:00 to 8:15, for example), the price of each and input fields for entering the quantity of each to be ordered are displayed, and if there is a special offer (special offer information) for any displayed menu item, it is displayed in a “Bargain Set Menus” item field. Then, by inputting the quantity to be ordered then pressing an “Order” button, the order data is transmitted to the managing server 4(S41).

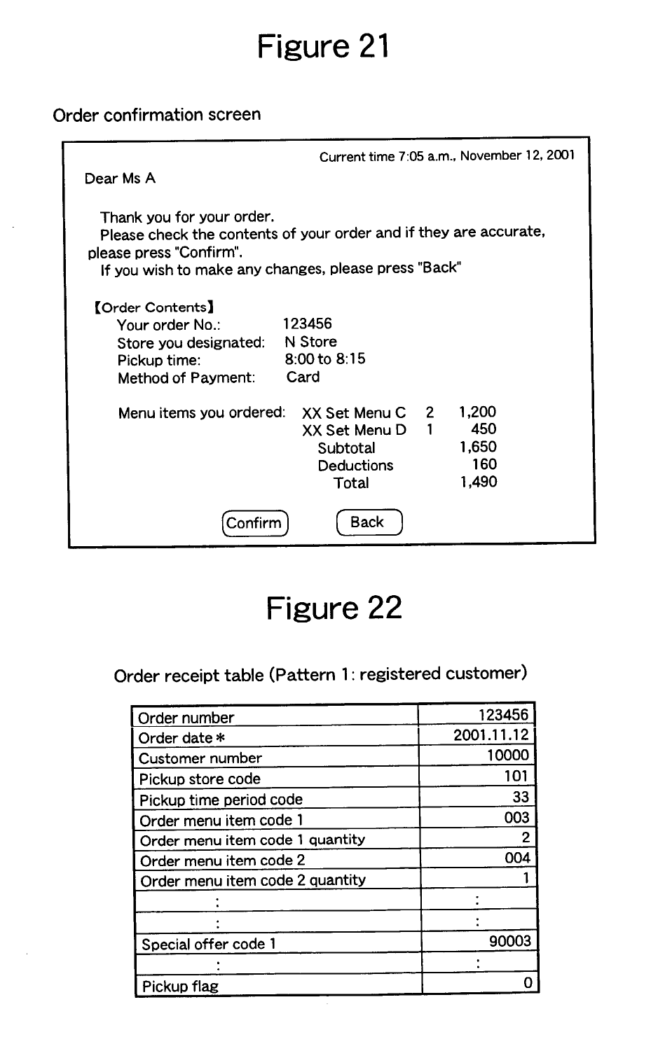

When the order data is received, the managing server 4 extracts the amount involved in the order from the menu information database 12A (S42), extracts the special offer information from the special offer information database 10A (S43), compiles these data as order confirmation data to be displayed on the display portion 37 of the customer terminal 1 as an order confirmation screen such as that shown in FIG. 21 (S44), and transmits the data to the customer terminal 1 (S45).

When the order confirmation data is received, an order confirmation screen such as that shown in FIG. 21 is displayed on the customer terminal 1. When the customer checks the contents and presses a “Confirm” button, confirmation certification data is transmitted to the managing server 4 (S46) and is registered in the order data database 17A as order data by the managing server 4 (S48).

FIG. 22 shows an order receipt table registered in the order data database 17A in this case. An order number, an order date, a customer number, a pickup store code, a pickup time period code, order menu item codes and the quantity thereof, special offer codes, a pickup flag, etc., are stored in the order receipt table. Moreover, if a “Back” button is pressed at the order confirmation screen in FIG. 21, it is possible to return to the menu item selection screen in FIG. 20 to reset the menu items, for example. Furthermore, when an unregistered person performs the operation from item “2.” on the order initial screen in FIG. 19, it is possible to perform processing such that only the menu information and pickup time are treated as order data, for example. An example of the order receipt table registered in that case by the order data database 17A is shown in FIG. 23. In the order receipt table in FIG. 23, the customer number is eliminated from the various items shown in FIG. 22. Thus, according to the present embodiment, even an unregistered person can use the present system within a limited scope, facilitating enlargement of the user base of the present invention. Of course, it goes without saying that unregistered persons may also be refused permission to use the present system.

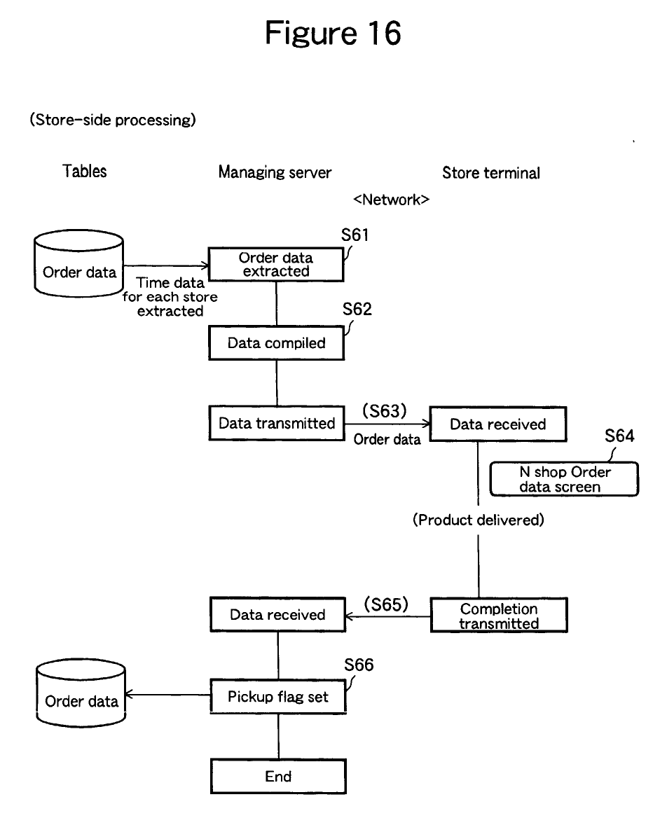

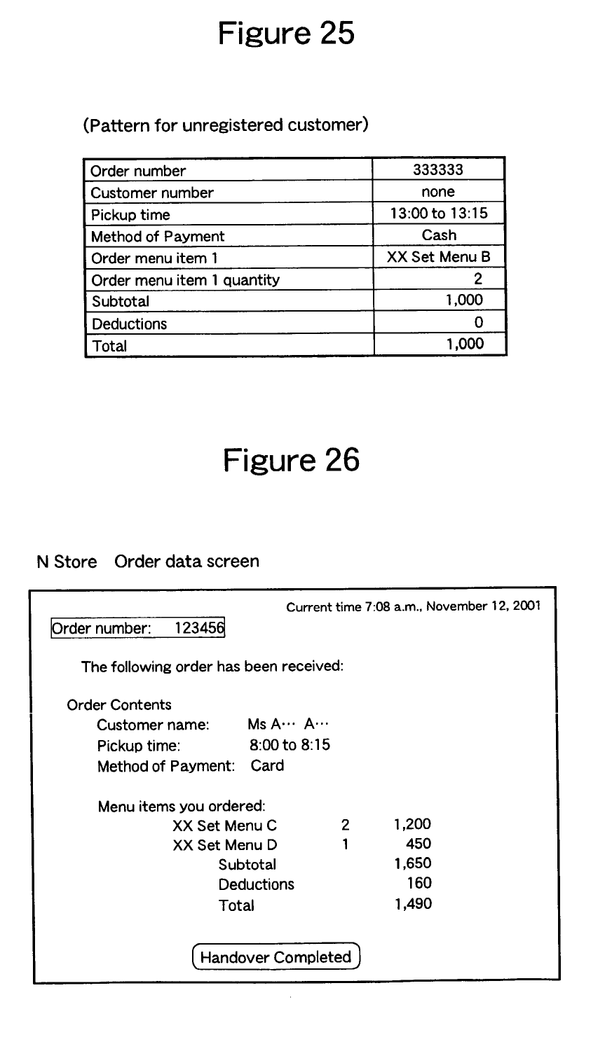

FIG. 16 is a flowchart showing processes performed between the managing server 4 and the store terminal 2. The managing server 4 extracts predetermined order data from the order receipt table stored in the order data database17A (S61), compiles it into store order data (S62), and transmits it to the store terminal (S63). For this store order data, order data shown in FIG. 24 is compiled so as to correspond to the order receipt table in FIG. 22, and includes the customer number, the pickup time, the method of payment, the order menu items and the quantity thereof, a subtotal, deductions when there are special offers (reductions), and a total amount payable. The order data shown in FIG. 25 is compiled so as to correspond to the order receipt table in FIG. 23, and compared to FIG. 24, there is no customer number and the method of payment is limited to cash.

Then, when the order data compiled by the managing server 4 is received, the store terminal 2 displays an order data display screen such as that shown in FIG. 26 (S64), and thus the store staff, etc., can be informed of the pickup time before the customer comes to the store and preparations can be made to hand over the products, enabling the handover of the products to be made without keeping the customer waiting if he or she comes to the store at the designated time. Moreover, the customer's name, the pickup time, the method of payment, the names of the products, and the numbers thereof are displayed as order contents in the order data display screen in FIG. 26, enabling the proposed products to be prepared at the store based on this display by the time the customer comes to the store.

When the handover of the products is completed, information that the handover has been completed is transmitted to the managing server 4 by pressing a “Handover Completed” button on the order data display screen (S65). Completion of transaction (transfer) of the products is recorded at the managing server 4 by overwriting the pickup flag on the order receipt table shown in FIG. 22 or 23 from “O” to “1” (S66).

Thus, in the preferred embodiment of the present invention, inquiries as to what kind of stores there are in a given area can be made from a customer terminal, and menus and special offers at a store selected based on the answer thereto can be downloaded and accessed, thus enabling reservations to be made for given menu items at a given store by designating a pickup time (a time of day for coming to the store), and the method of payment therefor can also be set, enabling sales productivity for the store to be increased by enabling the other hand, enabling the customer to designate products on the menu in advance before going to the store and to designate the time of day for coming to the store to pick the products up, eliminating the need to wait for a long time in order to pick the products up, and consequently making it possible for smooth and efficient commercial transactions to be performed. Moreover, in the present invention, the customer terminal may also be a portable terminal (information equipment) such as a portable telephone, etc., or it may also be a non-portable terminal (information equipment) such as a personal computer, etc. Furthermore, in the preferred embodiment, a case in which the products were food and beverages and the store was a food and beverage store such as a fast food store or a restaurant was given as an example but it goes without saying that the present invention is not limited to these and may be similarly applied to products other than food and beverages. In that case, inventory information, etc., can also be downloaded instead of downloading a menu.

As described above, the present invention exhibits the effect of providing a commercial transaction support apparatus, a commercial transaction support system, a customer terminal device, a commercial transaction support method, and a commercial transaction support program enabling product transactions between a store and a customer to be expedited and smoothed by enabling a menu available at the store at the time of transaction to be known beforehand, and consequently enabling transaction time to be shortened by enabling a product to be ordered immediately on arrival at the store, thereby enabling sales productivity to be increased for the store, and eliminating the need for long waiting times for the customer to purchase a product and also preventing the customer's expectations concerning the menu from being disappointed.

What is claimed is:

1. A commercial transaction support apparatus comprising:
a means for receiving as electronic data information relating to a store and a time of day;
a menu information extracting means for extracting from an information source menu information concerning a menu available at said store at said time of day; and
a means for transmitting as electronic data to a predetermined device said menu information extracted by said menu information extracting means.

2. The commercial transaction support apparatus according to claim 1, further comprising:
a storage means for storing menu information concerning a menu at said store in association with a time of day, said menu information extracting means extracting menu information using said storage means as said information source.

3. The commercial transaction support apparatus according to claim 1, further comprising:
a means for extracting from an information source special offer information related to said menu information extracted by said menu information extracting means and transmitting said special offer information in association with said menu information.

4. The commercial transaction support apparatus according to claim 1, further comprising:
a means for receiving as electronic data information concerning a commercial product selected based on said transmitted menu information; and
a means for displaying as order information information concerning said received commercial product and a time of day for trading said product.

5. The commercial transaction support apparatus according to claim 4, further comprising:
a means for obtaining as electronic data information relating to a method of payment by a customer for said commercial product,
said method of payment being displayed as order information together with said information concerning said commercial product and said time of day for trading said product.

6. The commercial transaction support apparatus according to claim 4, further comprising:
a managing means for managing said order information by electronic data.

7. The commercial transaction support apparatus according to claim 1, further comprising:
a means for receiving as electronic data inquiry information concerning a store in a predetermined area;
a store information extracting means for extracting as electronic data from an information source store information concerning said store in said predetermined area; and
a means for transmitting to a predetermined device as electronic data said store information extracted by said store information extracting means.

8. A commercial transaction support system for supporting a commercial transaction, said commercial transaction support system comprising:
a customer terminal device possessed by a customer; and
a server device capable of being connected to said customer terminal device by means of a communication line,
wherein:
said server device is provided with:
a means for receiving as electronic data from said customer terminal device information relating to a store and a time of day;
a menu information extracting means for extracting as electronic data from an information source menu information concerning a menu available at said store at said time of day; and
a means for transmitting as electronic data to said customer terminal device said menu information extracted by said menu information extracting means, and
said customer terminal device is provided with:
a means for displaying said menu information concerning said menu transmitted from said server device and enabling a desired commercial product to be selected and transmitted to said server device as electronic data.

9. A commercial transaction support system for supporting a commercial transaction, said commercial transaction support system comprising:
a customer terminal device possessed by a customer;
a store terminal device disposed in a store; and
a server device capable of being connected to said terminal devices by means of a communication line,
wherein:
said server device is provided with:
a means for receiving as electronic data from said customer terminal device information relating to a store and a time of day;
a menu information extracting means for extracting from an information source menu information concerning a menu available at said store at said time of day;
a means for transmitting as electronic data to said customer terminal device said menu information extracted by said menu information extracting means,
a means for receiving as electronic data information relating to a commercial product and a time of day for trading said product transmitted from said customer terminal device based on said transmitted menu information; and
a means for transmitting as electronic data to said store terminal device said received information relating to said commercial product and said time of day for trading said product,
said customer terminal device is provided with:
a means for displaying said menu information concerning said menu transmitted from said server device and enabling a desired commercial product and a time of day for trading said product to be selected and transmitted to said server device, and
said store terminal device is provided with:
a means for receiving and displaying said received information relating to said commercial product and said time of day for trading said product transmitted from said server device.

10. A customer terminal device capable of being connected to a predetermined device, said customer terminal apparatus comprising:
a means for transmitting as electronic data to said predetermined device information relating to a store and a time of day;
a means for receiving menu information concerning a menu available at said store at said time of day transmitted as electronic data from said predetermined device based on said information relating to said store and said time of day;
a means for displaying said received menu information and enabling selection of a desired product; and
a means for transmitting information concerning said selected desired product to said predetermined device as electronic data.

11. A commercial transaction support method comprising:
a step of receiving as electronic data information relating to a store and a time of day;
a step of extracting as electronic data from an information source menu information concerning a menu available at said store at said time of day; and
a step of transmitting said extracted menu information as electronic data to a predetermined device.

12. A commercial transaction support program recorded on a recording medium readable by a computer and executed by a computer of a commercial transaction support apparatus for supporting a commercial transaction, said commercial transaction support program executing in said computer:
a step of receiving information relating to a store and a time of day;
a step of extracting from an information source menu information concerning a menu available at said store at said time of day; and
a step of transmitting said extracted menu information to a predetermined device.
